(19) United States
(12) Patent Application Publication
(10) Pub. No.: US 2017/0305235 A1
(43) Pub. Date: Oct. 26, 2017

(54) PROCESS FOR COUPLING AN ELECTRIC MOTOR GENERATOR UNIT TO AN ENGINE OF A VEHICLE

(71) Applicant: TrybriDrive LLC, Sedona, CA (US)

(72) Inventors: Bruce Richard Berkson, Sedona, AZ (US); Sean Robert Scherer, Phenix, AZ (US); Phillip Steven Brown, Cornville, AZ (US)

(73) Assignee: TrybriDrive LLC, Sedona, CA (US)

(21) Appl. No.: 15/647,653

(22) Filed: Jul. 12, 2017

Related U.S. Application Data
(62) Division of application No. 15/475,763, filed on Mar. 31, 2017.
Application No. 15/475,763 is a continuation-in-part of application No. 14/861,883, filed on Sep. 22, 2015.
(60) Provisional application No. 62/071,519, filed on Sep. 25, 2014.

(51) Int. Cl. B60H 1/32; B60L 1/02; B60H 1/00; B62D 65/00; B60K 6/22

(52) U.S. Cl. CPC B60H 1/3222; B62D 65/00; B60K 6/22; B60L 1/02; B60H 1/004; B60H 2001/3294; B60Y 2304/07; B60Y 2306/07; Y10S 903/902; B60Y 2200/92

(57) ABSTRACT

Processes for converting and adapting a vehicle into a hybrid-driven vehicle include coupling an electric motor generator unit to an engine of the vehicle, including to a through-bolt extending through a crankshaft pulley. Also included is a process for converting a vehicle's mechanically-driven air conditioning compressor to operate as an electro-mechanical air conditioning compressor by detaching the air conditioning compressor from the crankshaft and operating the air conditioning compressor using an electric motor. A temperature of rechargeable vehicle batteries of an alternate power unit of the vehicle is managed and maintained at a predetermined desired temperature.

### RELATED APPLICATION

This is a Divisional of U.S. application Ser. No. 15/475,763, filed Mar. 31, 2017, which was a continuation-in-part of U.S. application Ser. No. 14/861,883, filed Sep. 22, 2015, which claims the benefit of U.S. Provisional Application Ser. No. 62/071,519, filed Sep. 25, 2014.

### BACKGROUND OF THE INVENTION

The present invention is generally related to vehicle hybrid electric drive power and temperature management. More particularly, the present invention is directed to systems and processes for converting a vehicle's mechanically-driven air conditioning compressor to operate as an electro-mechanical air conditioning compressor, coupling an electric motor generator unit to an engine of a vehicle, and managing the temperature of rechargeable vehicle batteries.

Studies reveal that vehicles which idle for prolonged periods of time, including, but not limited to, police vehicles, taxis, limousines, construction, delivery and utility trucks, burn thousands of gallons of fuel each year while idling. In many cases, idle times exceed drive times. The resulting wasted fuel and added maintenance costs are very high. It is well known in the trade that the damage to gasoline engines caused by engine glazing and to diesel engines caused by piston slap that results from long duration engine idling is significant. As a result, costly engine rebuilds are frequently required for prolonged-idle vehicles. It is also well known that when vehicle engines idle for prolonged periods of time, it may have the effect of cooling the catalytic converter, thereby increasing unburned hydrocarbon emissions from the engine and elevating nitrous oxide emission levels.

It has been found to be cost effective to develop idle reduction strategies that turn off the engine any time the vehicle is at rest and in a state of prolonged idle. However, experience has shown drivers often won't voluntarily turn off their cabin air conditioning or cabin heater when temperatures become uncomfortable and/or potentially unsafe.

Drivers of prolonged-idle vehicles, including police, taxis, limousines, construction and utility companies and the like, often use their radios, lights, heaters, air conditioning and other accessories while idling. These added accessories overload the original equipment manufacturers' (OEM) 12-volt electric systems and cause the batteries, starters and alternators to experience extremely high failure rates. When the OEM electrical alternator system is also used to recharge the idle reduction system batteries, as well as the OEM electric system, failure also frequently occurs. As a result, prolonged-idle vehicles with or without other idle reduction systems are often left inoperable due to battery and starter system failure.

Police vehicles which idle to power their accessories pose a significant security and safety risk when the vehicle must be left running, particularly when the driver must exit the vehicle. Police agencies have reported numerous accidental deaths of children, pets and K9 officers who were inadvertently left unattended in overheated vehicles.

Previous idle reduction systems and methods do not automatically detect or activate thermal or carbon monoxide or other contaminant occupant protection when a passenger occupies the vehicle. Previous idle reduction systems and methods do not integrate adaptive electro-mechanical air conditioning or electric space heating with the OEM HVAC systems. Previous idle reduction systems typically exceed OEM 12-volt electrical system capacities, and do not provide autonomous charge-sustaining operation.

Previous idle reduction systems and methods do not provide adaptive hybrid drive capability nor adaptive hybrid drive regenerative electric braking.

Previous idle reduction systems and methods do not provide an alternate power unit that enables stored energy to be distributed as a transportable electric grid micro source. Moreover, such previous idle reduction systems do not thermally manage the rechargeable batteries of the alternate power unit and related controllers.

Previous hybrid idle reduction system methods that idle for prolonged times may allow the catalytic converter temperature to drop below an effective range, causing increased nitrous oxide emissions during subsequent duty cycles. Nor do previous idle reduction systems and methods capture the wasted cold air from the low pressure lines of the air conditioning system in order to introduce cold air into the engine air intake manifold, improving complete engine combustion, fuel efficiency and power.

It is well known that the distributed electric infrastructure required to recharge fleets of hybrid or electric vehicles is either limited or virtually non-existent. It is also well known that the cost to install large distributed electric recharging systems is extremely expensive. Previous idle reduction systems do not provide autonomous charge-sustaining operation, and previous vehicles using electric air conditioning are susceptible to motor controller failure due to high operating temperatures.

Prior art vehicles typically incorporate a motor generator unit into a modified pulley and belt system. Moreover, prior art vehicles couple and drive air conditioning compressor units with a belt drive. This requires that the internal combustion engine be running in order for the air conditioning compressor to function and operate and provide cool air, such as to the passenger compartment of the vehicle. Furthermore, coupling such devices to the belts places a strain on the belts and related components and decreases efficiency.

Accordingly, there is a continuing need for a system and method for converting a vehicle's mechanically driven air conditioning compressor to operate as an electro-mechanical air conditioning compressor and be selectively operated by an electric motor. There is also a continuing need for a system and method for coupling an electric motor generator unit to a crankshaft of the vehicle without the need for reconfiguring existing belts or providing additional belts. Moreover, there is a continuing need for a system and method for managing the temperature of rechargeable vehicle batteries. The present invention fulfills these needs, and provides other related advantages.

### SUMMARY OF THE INVENTION

The present invention is generally concerned with methods and systems for adapting a vehicle to a hybrid drive vehicle having an energy storage and distribution system while providing fuel efficiency and improved fuel emissions and safety. In accordance with the methods and systems of the present invention, a conventional internal combustion engine-based vehicle can be converted and adapted into a hybrid drive vehicle which has these benefits.

In addition to a primary alternator coupled to the engine, a motor generator unit that generates electricity is coupled to the engine, in accordance with the invention. In a particularly preferred embodiment, a rotatable shaft of the motor generator unit is operably coupled to the crankshaft. This may be done by attaching a coupling between the motor generator shaft and the through-bolt of the crankshaft. Typically, fasteners are inserted through a mounting flange and into the crankshaft pulley or wall of the engine. The mounting flange and motor generator unit are attached to the crankshaft without coming into direct contact with a harmonic balancer, sometimes referred to as a vibration dampener, of the crankshaft pulley. A second end of the motor generator unit generally opposite the crankshaft may be supported, such as by a bracket attached to an adjacent structure of the engine or within the engine compartment.

The present invention also provides systems and processes for converting a vehicle's mechanically-driven air conditioning compressor to operate as an electro-mechanical air conditioning compressor. Conventionally, a drive belt is operably coupled to a crankshaft of the engine and an air conditioning compressor. The drive belt from the air conditioning compressor is detached in accordance with the present invention. An electric motor is operably attached to the air conditioning compressor instead. This may be done by attaching the electric motor to a clutch or pulley of the air conditioning compressor. The air conditioning compressor may be coupled to the electric motor by a bracket. The electric motor operates the air conditioning compressor. For example, an electronic controller selectively activates the electric motor and causes the air conditioning compressor to operate. This may be done when a temperature within a passenger compartment of the vehicle detects a temperature falling outside of a predetermined range of temperatures, thus activating the electric motor and air conditioning compressor.

In addition to a battery electrically coupled to the primary alternator for starting the engine of the vehicle, the present invention provides an alternate power unit comprising rechargeable batteries electrically coupled to the motor generator unit. The rechargeable batteries may provide electric power to various components and systems of the vehicle, such as the aforementioned converted electro-mechanical air compressor, the motor generator unit to supply power to the crankshaft of the engine, electrically powered lights and other accessories.

In accordance with the present invention, the temperature of the rechargeable vehicle batteries is managed. Typically, the rechargeable batteries are disposed within a housing of the alternate power unit. A temperature of the interior housing is detected. As necessary, the interior of the housing is cooled, to cool the batteries, when the detected temperature is above a predetermined temperature, such as 90° F. This may be done by passing air through an evaporator to cool the air and direct the cooled air into the housing to cool the batteries. A refrigerant may be passed from a low pressure line of an air conditioning compressor of the vehicle through the evaporator. The alternate power unit may have a dedicated air conditioning unit comprising a condenser, a compressor, and an accumulator to cool the interior of the housing of the alternate power unit, and thus the rechargeable batteries. However, the interior of the housing may be heated when a detected temperature falls below a predetermined temperature. In order to heat the interior of the housing of the alternate power unit, and thus the batteries, electricity may be provided to electrical heating elements associated with the housing or the batteries.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view and diagram illustrating a conventional engine arrangement in accordance with the prior art which incorporates a mechanical air conditioning compressor, an alternator, and a crankshaft pulley coupled to one another by a belt;

FIG. 2 is a diagrammatic view illustrating the generation and supply of electricity to and from rechargeable batteries of an alternate power unit and an internal combustion engine by means of a motor generator unit and/or regenerative brakes;

FIG. 3 is a diagrammatic view of a vehicle having sensors detecting conditions in an occupied compartment thereof, in accordance with the present invention;

FIG. 4 is a diagrammatic view similar to FIG. 1, illustrating the incorporation of a motor generator unit and sensors and electronic controllers operably coupled to the motor generator unit and engine and alternate power unit, in accordance with the present invention;

FIG. 5 is a partially exploded perspective view of a motor generator unit coupled directly to a through-bolt of a crankshaft pulley, in accordance with the present invention;

FIG. 6 is an end view of a flange for attaching the motor generator unit to the crankshaft, in accordance with the present invention;

FIG. 7 is a cross-sectional view taken generally along line 7-7 of FIG. 6, illustrating attachment of the various component parts thereof;

FIG. 8 is a diagrammatic view similar to FIGS. 1 and 3, but illustrating an electro-mechanical air conditioning compressor embodying the present invention;

FIG. 9 is a perspective and diagrammatic view illustrating the coupling of an electric motor with the air conditioning compressor unit, in accordance with the present invention;

FIG. 10 is a diagrammatic view illustrating an alternate power unit having rechargeable batteries and components for detecting and managing the temperature of the batteries; and

FIG. 11 is a diagrammatic and perspective view similar to FIG. 10, but illustrating a self-contained, dedicated miniature air conditioning system for managing the temperature of the enclosure of the rechargeable batteries of the alternate power unit, in accordance with the present invention.

### DETAILED DESCRIPTION OF THE PREFERRED EMBODIMENTS

As shown in the accompanying drawings, for purposes of illustration, the present invention is directed to systems and processes for converting and adapting conventional internal combustion-based vehicles into hybrid vehicles which continue to use the internal combustion engine but also capture, store and use electricity in both driving the vehicle as well as operating various accessories associated with the vehicle. These conversions and adaptations can take place at the factory, but more typically are retrofit to existing internal combustion-based vehicles wherein modifications are made to the existing vehicle in order to give the vehicle electric hybrid qualities and characteristics. The system and method of the present invention can reduce or even eliminate periods of prolonged vehicle idling. The present invention can also prolong the usable life of components of a conventional vehicle, and thus result in cost savings due to maintenance, replacement of parts, and fuel.

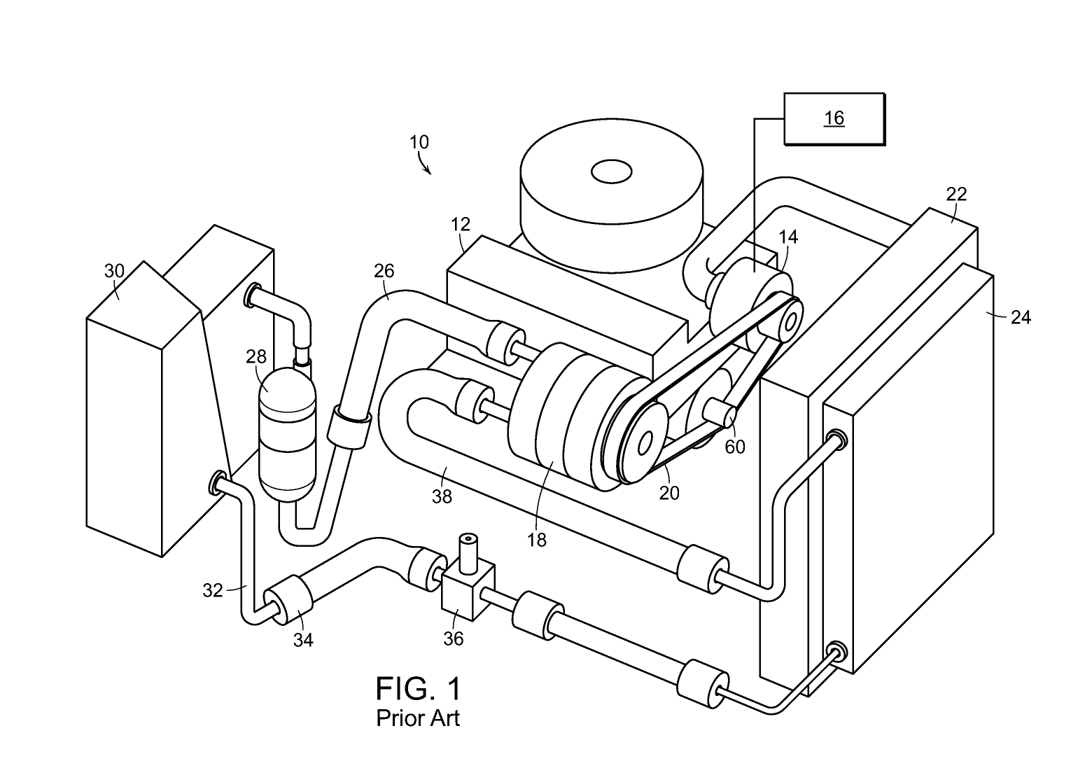

With reference now to FIG. 1, a conventional engine 10, typically an internal combustion engine, is shown. The engine 10 includes an engine block 12 having the typical pistons, crankshafts, camshafts, and the like. An alternator 14 is typically mounted onto the engine block and generates electricity for charging the vehicle's battery 16, typically a 12-volt battery. A mechanical air conditioning compressor 18 is also mounted to, or otherwise associated with, the engine 10 for creating cool air, as is known in the art. A system of belts and pulleys 20 impart rotational energy from a crankshaft of the engine 10 to the alternator 14 and the mechanical air conditioning compressor 18 in order to operate these components, as is known in the art.

As is well known in the art, engines typically have a radiator 22 and a condenser 24 for thermal management of the engine and its components. Conventionally, in order to provide cool, conditioned air to the passenger compartment of the vehicle, refrigerant, such as Freon®, is compressed by the mechanical air conditioning compressor 18 passed through tubing 26 to an accumulator 28 where it is then passed to an evaporator 30, where the evaporation of the compressed refrigerant creates a thermal condition where cool air can be generated. The evaporated refrigerant is then passed through tubing 32, through one or more orifices 34, a refrigerant charge tube 36, and then onto the condenser 24, before being returned via tubing 38 to the mechanical air conditioning compressor 18.

Conventionally, heated air is provided from heat generated by the engine and/or radiator 22 and piped into the passenger compartment, through filters, as desired.

In order to create and direct cooled or heated air into the passenger compartment of the vehicle, in the prior art, the engine must be running. Thus, there are many situations where when a vehicle is parked the driver of the vehicle leaves the engine idling so as to maintain the desired temperature within the passenger compartment of the vehicle. This requires expenditure of fuel and the operation of the aforementioned components. Moreover, in certain situations carbon monoxide levels within the passenger compartment can become elevated, posing a danger and threat to the occupants of the passenger compartment, when the vehicle is idling.

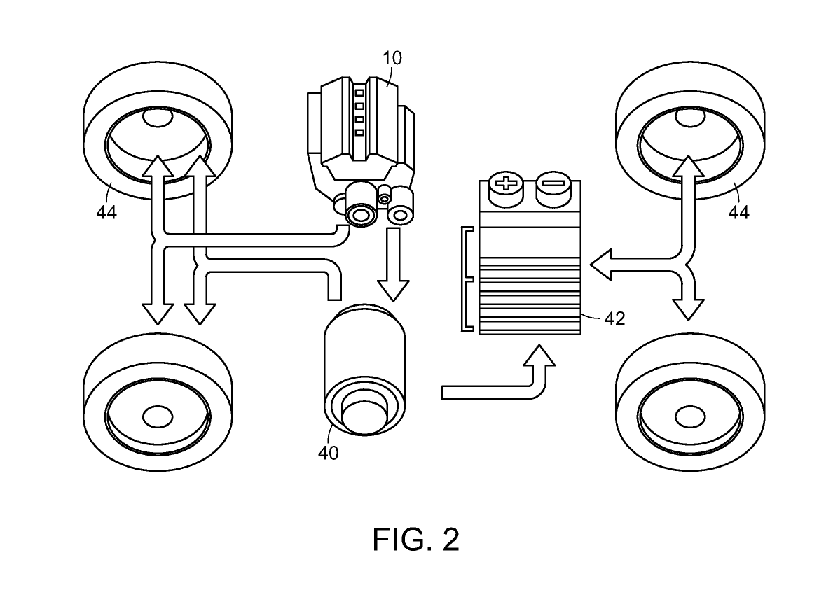

With reference now to FIG. 2, in accordance with the present invention, various components of a conventional engine 10 and other systems and components of the vehicle are changed, altered, or have additions made thereto, either at the time of manufacturing or as a process of retrofitting the vehicle to incorporate the aspects of the present invention. As shown schematically and diagrammatically in FIG. 2, a motor generator unit 40 is associated with the engine 10. The motor generator unit 10 can generate power, in the form of electricity, which can be supplied to rechargeable batteries of an alternate power unit 42, in accordance with the present invention. Regenerative electric brakes, diagrammatically illustrated as component 44, can also create electricity which may be utilized to recharge the batteries of the alternate power unit 42 or supply other components and systems of the vehicle with electricity, as needed. Both the motor generator unit 40 and the regenerative braking system 44 may also supply power to the engine 10 so as to increase fuel efficiency of the engine 10, and thus the vehicle. In accordance with the present invention, modular thermally managed rechargeable batteries in the alternate power unit 42 store energy to be distributed as a transportable electric grid micro source.

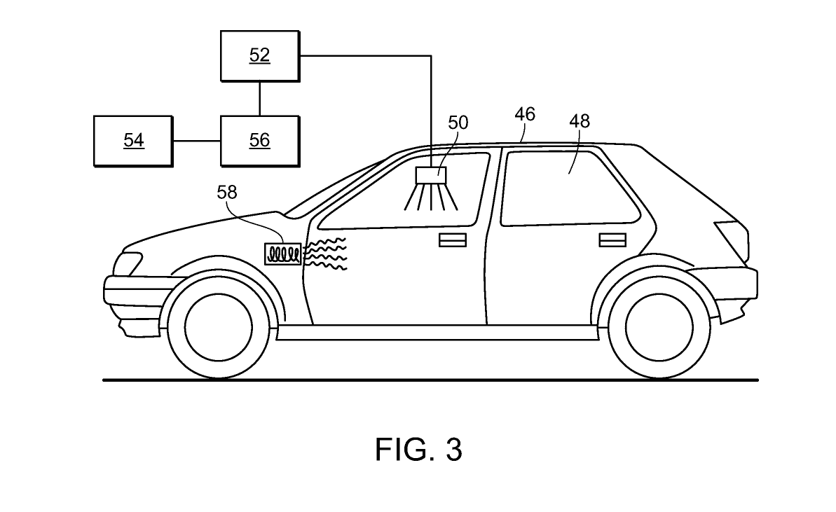

With reference now to FIG. 3, a vehicle 46 is illustrated. It will be appreciated that the vehicle 46 can comprise any type of passenger vehicle, typically including an automobile in the form of a car, truck, and the like. The vehicle 46 has therein a passenger compartment 48 where the driver sits to operate the vehicle 46 and passengers may be seated, as is well known.

In accordance with an aspect of the present invention, one or more sensors 50 sense and detect parameters and conditions within the passenger compartment 48. Such sensors include a sensor for sensing carbon monoxide levels in the passenger compartment, a sensor for sensing the temperature in the passenger compartment of the vehicle, and a sensor for detecting the presence of a living occupant within the passenger compartment. The detection of a living occupant within the passenger compartment 48 can be by means of a motion detector, an infrared sensor, pressure sensors in the seats of the vehicle, or any other sensor which could detect that an occupant is within the passenger compartment 48 of the vehicle 46. Sensors 50 may also detect contaminants within the passenger compartment including chemical levels, aerosol biological levels and even nuclear levels within the occupied passenger compartment of the vehicle in order to protect the occupants thereof as well as reducing unnecessary idling of the engine of the vehicle.

A controller 52 is operably connected to the one or more sensors 50. The controller 52 is also operably coupled to an electric heating system 54 and an electric cooling system 56 embodying the present invention. The system typically also has a blower 58 for blowing cool air from the electric cooling system 56 or OEM cooling system, heated air from the electric heating system 54 or OEM heating system, or air from outside of the vehicle into the passenger compartment 48 of the vehicle 46. This may be the case, for example, if air outside of the vehicle is at a more desirable temperature than the air within the passenger compartment 48 or the contaminant levels within the air of the passenger compartment 48 are determined to be too high and the blowers 58 may blow filtered air that may be used to flush out the contaminated air from within the passenger compartment 48 of the vehicle 46.

If the temperature within the passenger compartment 48 is detected as falling outside of a predetermined range of temperatures, the controller 52 activates either a heating system 54 or a cooling system 56 to bring the temperatures within the passenger compartment within the predetermined temperature range. These may be electric instead of the standard air conditioning and heating systems. For example, the temperature range may be set between 60° F. to 85° F. The passenger and/or user of the vehicle 46 may be able to adjust the thermostat to a desired internal temperature within the passenger compartment 48, and the air entering the passenger compartment will be heated or cooled accordingly. A particularly preferred temperature range is between 72° F. and 76° F., which could be set as a default. The controller 52 is also operably connected to the engine 10 such that it can shut off the engine when the sensors 100 detect that the carbon monoxide level within the passenger compartment 42 rises above a predetermined level. The controller 102 may also be used to shut off the engine and prevent it from idling unnecessarily. The invention contemplates the automatic restart of the engine, such as when the driver depresses the gas pedal of the vehicle.

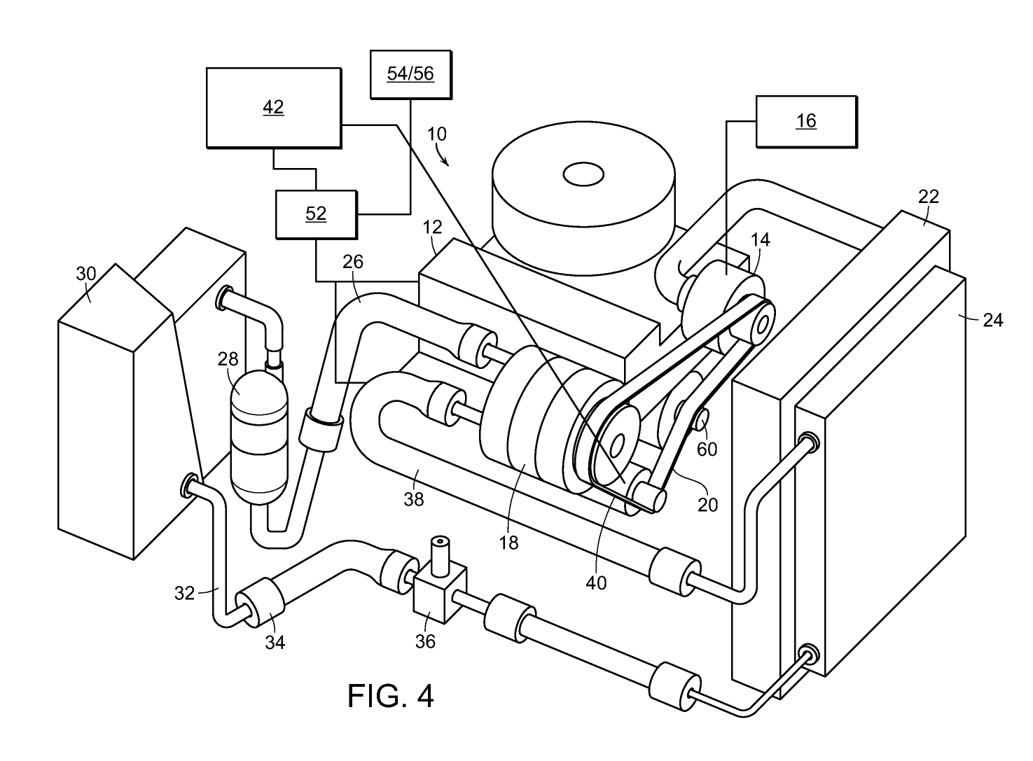

With reference to FIG. 4, the alternate power unit 42 is operably coupled to the one or more controllers 52, and electrically coupled to the motor generator unit 40. The alternate power unit 42 is used to provide electricity to the electric heating system 54 and the electric cooling system 56 of the present invention. Preferably, electrically-powered lights and other accessories of the vehicle 46 are also powered by the alternate power unit 42. This enables the original equipment manufacturing (OEM) battery 16 and alternator 14 to be dedicated to starting the engine, and thus prolonging their usable lives.

When the battery cells of the alternate power unit (APU) 42 are fully charged, the invention contemplates the motor generator unit 40 diverting power to the engine 10, such as a crankshaft of the engine, so as to conserve fuel. As such, the motor generator unit 40 is interactively connected to the alternate power unit, such as being monitored and controlled by controller 50, wherein it either charges the APU or returns hybrid electric power back to the crankshaft through an idler pulley belt, for example.

When an occupant of any type, size or weight is located within the vehicle, which can include adults, children, or even pets, the appropriate sensor 50 detects the presence of the occupants and automatically activates the thermal climate control systems 54 and/or 56 of the present invention. If the engine is running and the vehicle is moving, the OEM heating system may be used to heat the passenger compartment. This can also be the case when the vehicle is parked and in idle, and the system of the present invention does not detect abnormal levels of carbon monoxide and the engine is not automatically shut off. However, in the case when the engine is shut off, such as the present invention automatically shutting off the engine to conserve fuel, such as when a transmission lever of the vehicle is put into the park position, an electric heater 54 powered by the alternate power unit 42 may be used to provide heat, as necessary, to the passenger compartment 42. For example, electric heat strips may be placed in the heater vents and powered by the alternate power unit (APU) 42.

As shown in FIG. 4, the motor generator unit 40 is operably coupled to the crankshaft, such as through crankshaft pulley 60, through the serpentine belt 20 which may also be connected to the alternator 14 and the air conditioning compressor unit 18. Rotation of the belt 20 activates the motor generator unit 40 to create electricity, which is supplied, for example, to the batteries of the alternate power unit 42 and other electrical accessories of the vehicle, as needed. The motor generator unit 40 can also supply motive power to the vehicle, such as assisting rotation of the crankshaft or the like.

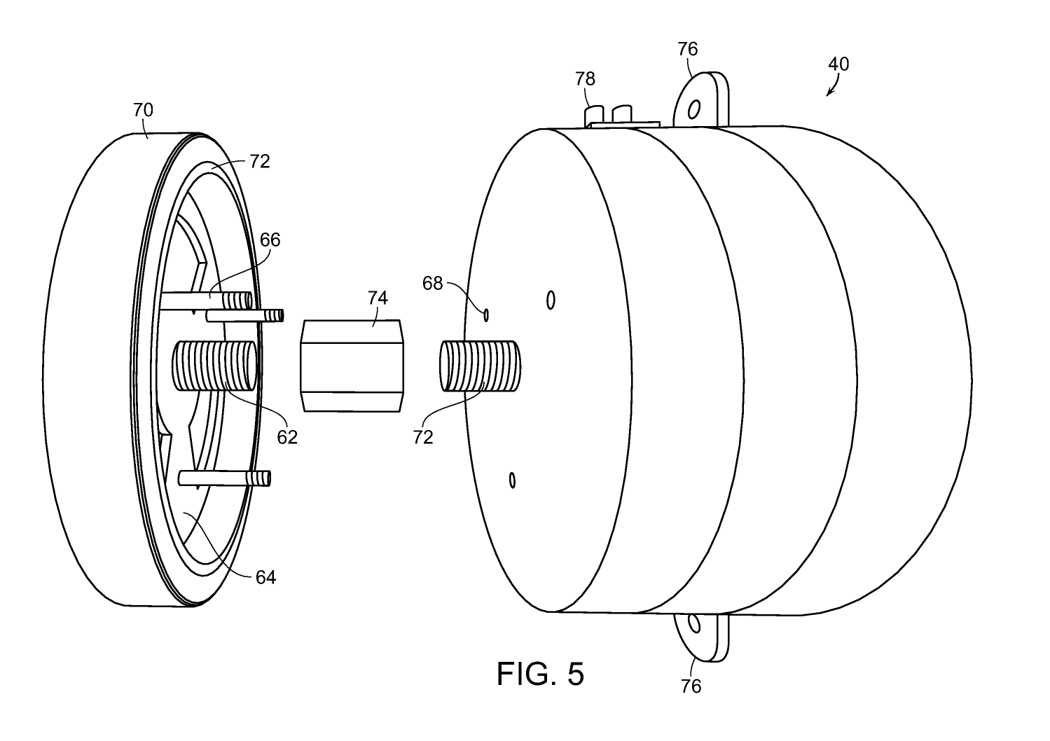

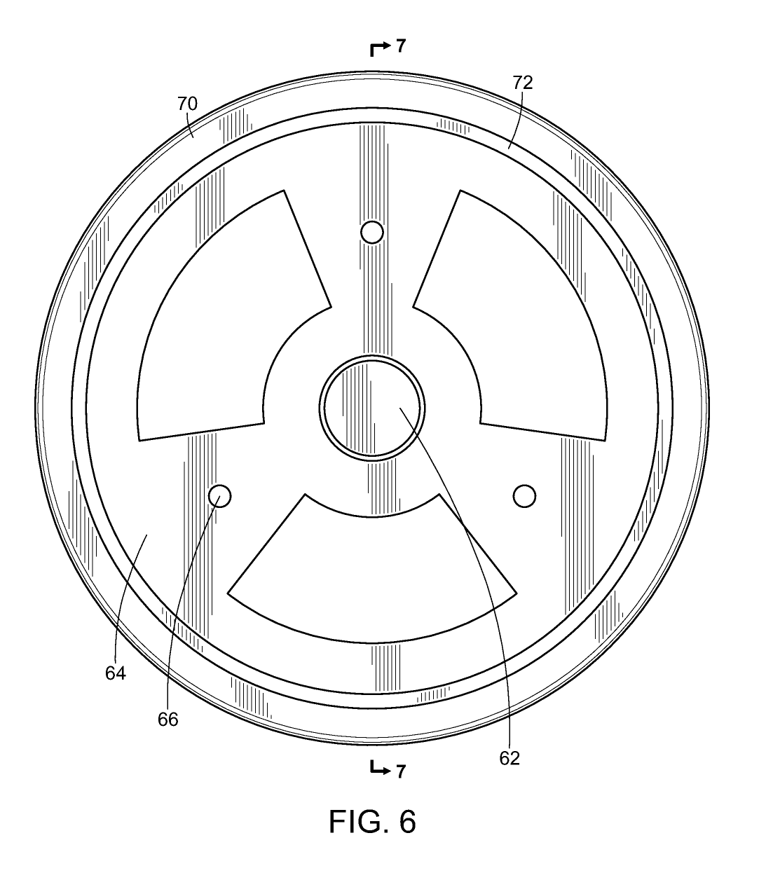

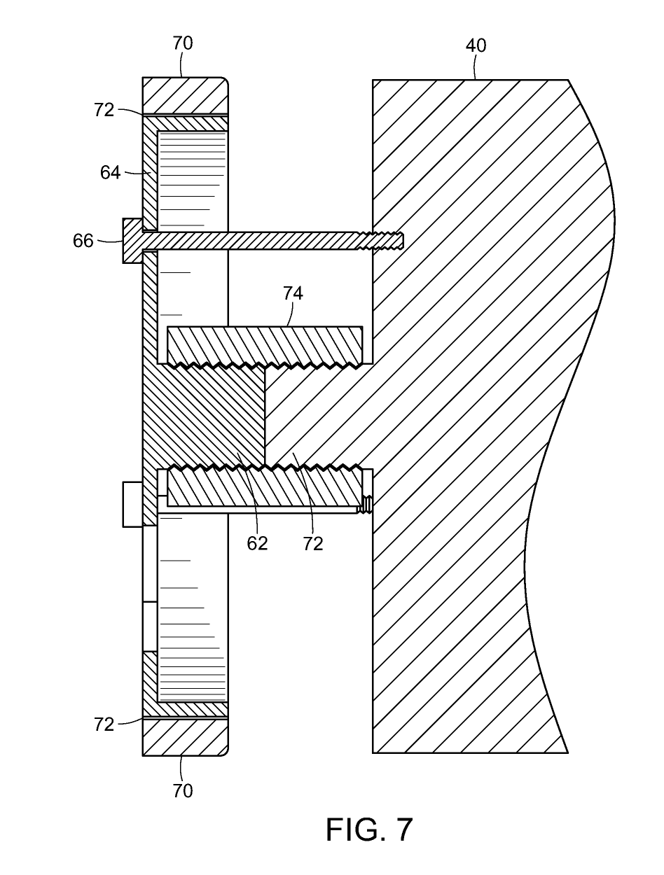

With reference now to FIGS. 5-7, the present invention contemplates coupling the motor generator unit 40 directly to the through-bolt 62 of the crankshaft or crankshaft pulley. This is done by attaching a flange 64, such as the illustrated circular flange, directly to a wall of the internal combustion engine or other non-moving structure within the pulley 60 of the crankshaft of the vehicle. Bolts 66 or other fasteners extend through the flange 64 and into the structure within pulley 60 at one end thereof, and into aperture 68 of the motor generator unit 40 at the other end thereof. The flange 64 is not in contact with a harmonic balancer or vibration dampener 70 associated with the crankshaft pulley 60. For example, there is a space 72 between the outer circumference of the generally circular flange 64 and the inner diameter surface of the harmonic balancer 70, as shown in FIG. 5. A rotatable shaft 72 of the motor generator unit 40 is coupled or otherwise attached to the through-bolt 62 of the crankshaft pulley by means of a coupler 74 or other fastener such that rotational energies are imparted between the through-bolt 62 and shaft 72.

The flange 64 serves to mount the motor generator unit 40 at one end thereof to the crankshaft pulley so that the through-bolt 62 of the crankshaft pulley and the shaft 72 of the motor generator unit 40 can be operably coupled to one another. The generally opposite second end of the motor generator unit 40 can be supported as well, such as by utilizing a bracket 76 to attach the second end of the motor generator unit 40 to a structure associated with the internal combustion engine or disposed adjacent thereto such as within an engine compartment of the vehicle.

Electric contacts or terminals 78 are operably coupled to the motor generator unit 40 for transferring electricity between the motor generator unit 40 and the alternating power unit batteries, accessory or the like. When in the battery charging mode, electricity is conveyed from the motor generator unit 40 to the rechargeable batteries of the alternate power unit 42. However, electricity can be supplied to the motor generator unit 40, such as by the batteries of the alternate power unit 42 so as to apply power to the through-bolt 62 of the crankshaft and provide motive power to the crankshaft so as to conserve energy and make the vehicle more fuel efficient.

Typically, the motor generator unit 40 is coupled to a belt 20, as illustrated in FIG. 4, however, mounting the motor generator unit 40 directly to the crankshaft output shaft bolt 62 and isolating the harmonic balancer 70 with the flange 64 allows almost any vehicle to be converted to a hybrid electric drive. This also enables the installer to utilize the existing belts and pulley arrangements, such as between the crankshaft pulley 60, alternator 14, air conditioning compressor 18, etc. Aside from simplifying the installation and allowing the conversion of almost any car or truck with a more powerful hybrid drive motor, the system has the appearance of being factory installed.

The present invention is also directed to a process for converting a vehicle's mechanically driven air conditioning compressor 18 to operate as an electro-mechanical air conditioning compressor. As shown in FIG. 1, typically the air conditioning compressor 18 is operably coupled to the crankshaft pulley 60 by means of a belt 20. Typically, a clutch of the air conditioning compressor is selectively actuated in order to have the belt 20 operate the air conditioning compressor 18 as the crankshaft pulley 60 is rotated, so as to rotate the internal components of the air conditioning compressor and compress the refrigerant, as is well known in the art.

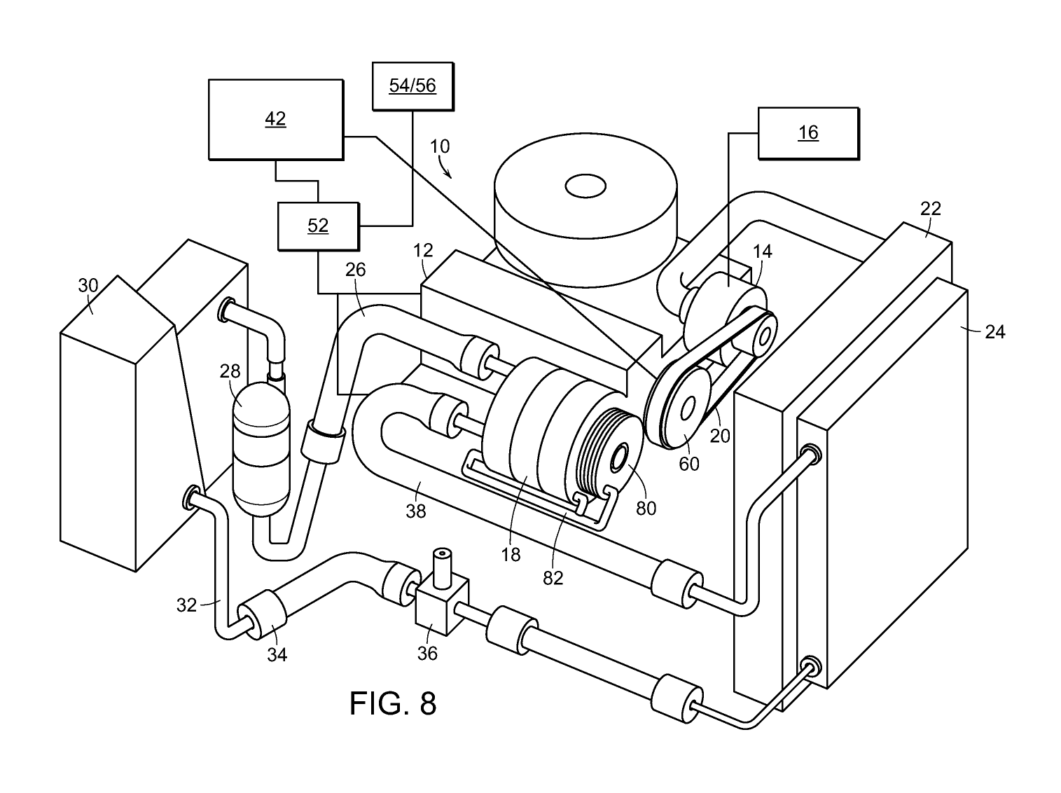

However, in accordance with the present invention, as illustrated in FIG. 8, the drive belt 20 is detached from the air conditioning compressor 18. An electric motor 80 is operably attached to the air conditioning compressor 18, such as by operably attaching the electric motor 80 to a clutch or pulley 88 of the air conditioning compressor 18, and using the electric motor 80 to operate the air conditioning compressor as desired. For example, the electronic controller 52 may selectively activate the electric motor 80 and cause the air conditioning compressor 18 to operate. This may occur when a temperature within the passenger compartment of the vehicle is detected as being outside of a predetermined range of temperatures. This may be dictated by the user and occupant of the vehicle setting a desired temperature, or a range of temperatures, such as generally between 60° F.-85° F. The system may be automatically set at a narrower temperature range, such as between 70° F. to 77° F., with the preferred temperature setting of 72° F. If the detected temperature within the compartment of the vehicle exceeds this temperature or temperature range, the electronic controller 52 selectively activates the electric motor 80, causing the air conditioning compressor 18 to operate and cool air to be distributed into the passenger compartment.

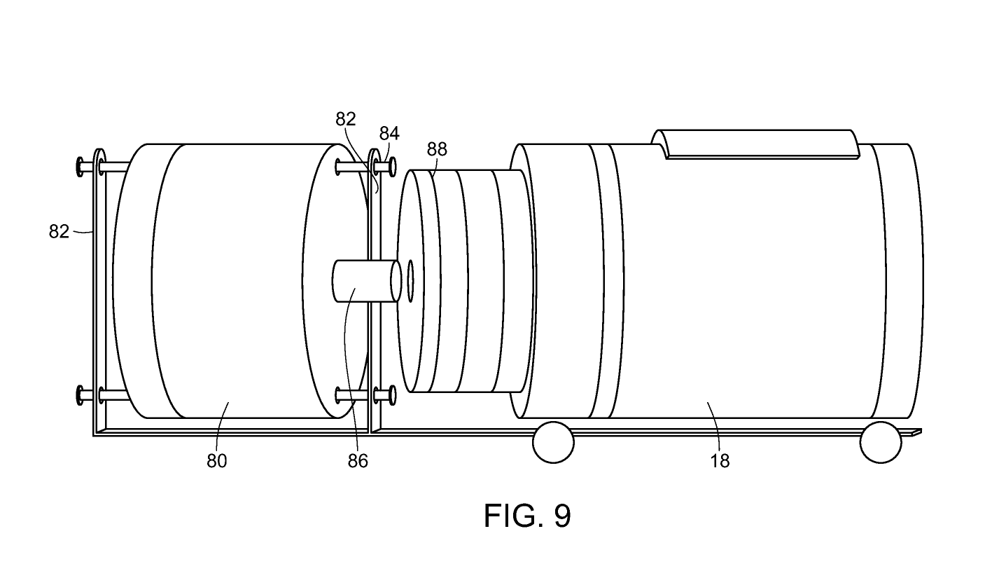

As illustrated in FIGS. 8 and 9, one or more brackets 82 may be used to connect the electric motor 80 to the air conditioning compressor 18, by use of bolts 84 or other fasteners. A rotatable shaft 86 of the electric motor 80 may be used to selectively activate and operate the air conditioning compressor 18. As discussed above, the electric motor 80 may be operably connected to the clutch or pulley 88 of the air conditioning compressor 18 to selectively activate and operate the air conditioning compressor 18.

There are benefits of converting the mechanically driven air conditioning compressor to operate as an electro-mechanical air conditioning compressor in that the air conditioning compressor 18 can be moved to a more desirable location and does not need to be positioned to accept belt 20 to operate. Another advantage is that the air conditioning compressor 18 can be operated when the internal combustion engine 10 is not running, but instead the air conditioning compressor 18 is operating by means of electrical power, such as that provided by the alternate power unit 42. Motor 80 may be a small drive motor such as an approximately 3 KW pancake motor or axial flux motor. Another advantage of utilizing the electric motor to operate the air conditioning compressor 18 is that it eliminates the weak link and energy transfer loss of the drive belt. Not only may the air conditioning compressor 18 itself be moved to a more convenient or desired location, but the refrigerant lines from the converted electro-mechanical air conditioning compressor may be rerouted and strategically placed in any appropriate location in the vehicle, as desired or needed.

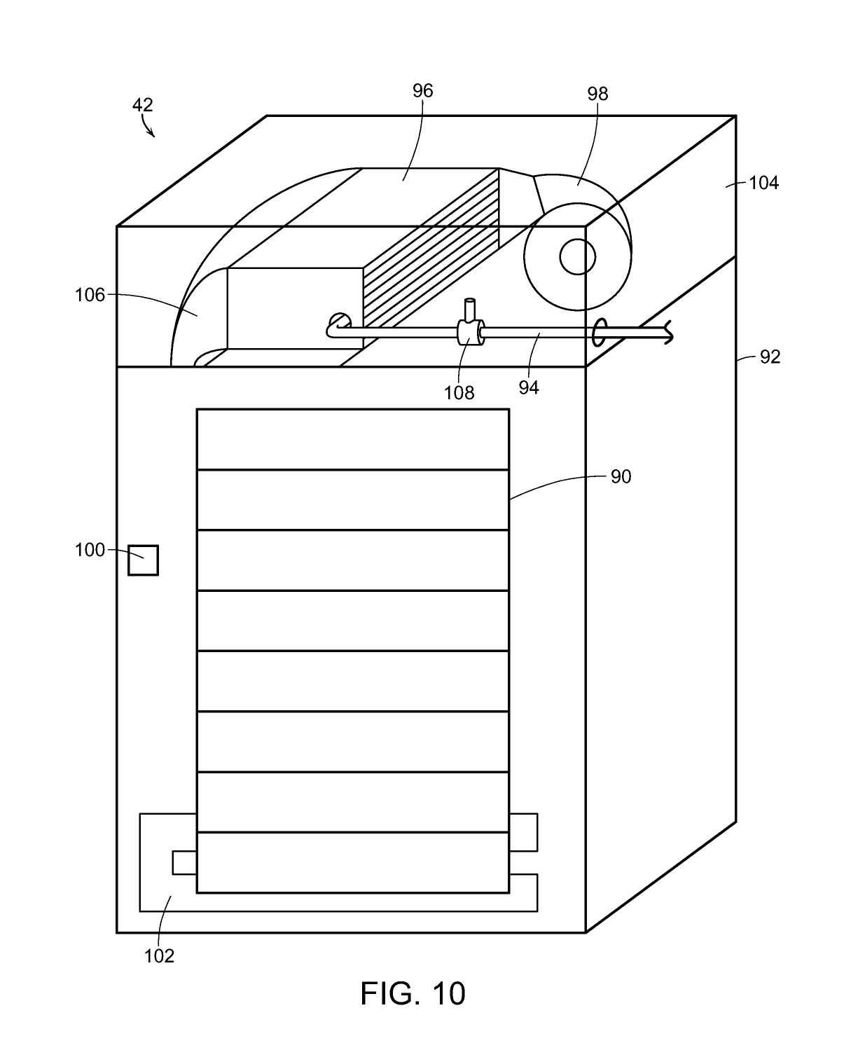

With reference now to FIG. 10, this can be advantageously used, for example, in managing the temperature of rechargeable vehicle batteries 90 within an enclosure or housing 92 of the alternate power unit 42. Low pressure refrigerant, such as Freon®, is passed through tube 94 into evaporator 96 where it is allowed to expand, and thus cool the air within the evaporator 96. A fan 98 is used to direct air over the evaporator 96 and into the enclosure 92 to cool the batteries 90, as needed or desired. A sensor 100 may detect the temperature of the interior of the housing 92. The interior of the housing 92 is selectively cooled when the detected temperature is above a predetermined temperature, such as 90° F.

The interior of the housing 92 may also be heated, as necessary or desired, in order to maintain the rechargeable batteries 90 within a predetermined temperature range. Thus, when sensor 100 detects that the temperature within the housing 92 is below a predetermined lower temperature threshold, the interior of the housing 92 may be heated. This may be done, for example, by supplying electricity to electric heating elements 102, which may be disposed, such as on the floor or lower portion of the housing 92 to heat the interior of the housing 92, and more particularly the rechargeable batteries 90 so as to maintain the temperature of the rechargeable batteries 90 within a desired temperature range. Various components of the system, such as the aforementioned refrigerant line 94, evaporator 96 and fan 98 may be disposed within an upper chamber or lid 104 of the alternate power unit 42 with an air duct 106 extending into the housing 92 where the rechargeable batteries 90 reside.

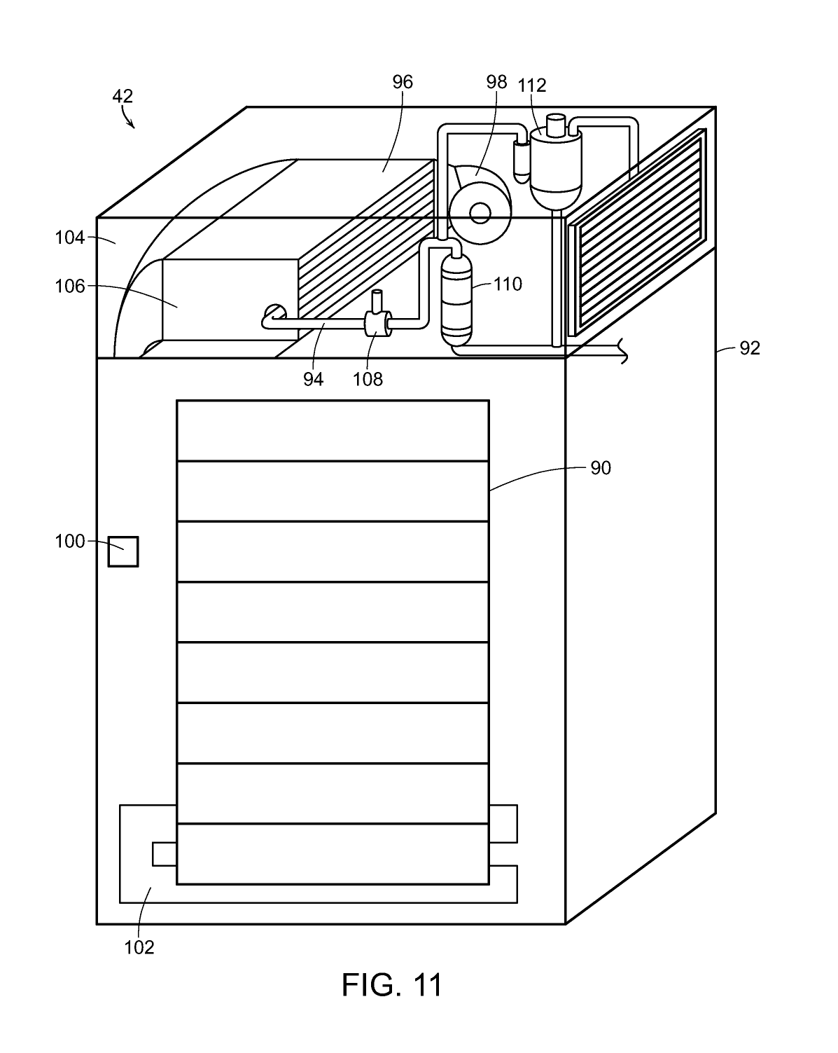

With reference now to FIG. 11, the alternate power unit 42 may have a dedicated air conditioning unit or system for managing the temperature of the rechargeable batteries 90. While this is illustrated being in the upper chamber or lid 104 of the alternate power unit 42, it will be understood that varying configurations would still meet the needs and goals of the present invention. Such an alternate power unit dedicated air conditioning unit would include and comprise the aforementioned evaporator 96 and fan or blower 98 as well as an expansion valve 108 disposed in a refrigerant line 94. The micro-sized A/C system or unit would also comprise a condenser 110, compressor 112 and may include an accumulator and any other necessary components to create a closed-circuit and self-contained micro-sized A/C system or unit which could supply cold air through duct 106 into the interior of the housing 92 to cool the rechargeable batteries 90 of the alternate power unit 42 as needed or desired.

However, when not utilizing the micro-sized A/C dedicated unit, it will be understood that the air conditioning refrigerant lines may be properly drained and capped, the low pressure refrigerant line of the converted electro-mechanical air conditioning compressor routed through the modular evaporator 96, and the air conditioning lines being rerouted back to the electro-mechanical air conditioning compressor as illustrated and described above. Valves or the like could be actuated so as to direct compressed refrigerant into the evaporator 96 and activate fan or blower 98 to direct cold air into the enclosure 92, as needed. Once again, this could be done when the internal combustion engine 10 is not operating as the air conditioning compressor has been converted to an electro-mechanical air conditioning compressor, as illustrated and described above. However, it is also contemplated by the present invention that the OEM air conditioning compressor arrangement be used with added or rerouted refrigerant lines to maintain the temperature of the rechargeable batteries 90 within the housing 92 of the alternate power unit 42, as needed or desired.

The cold air from the low pressure lines of the electro-mechanical air conditioning system, or even the mechanical air conditioning system, such as that directed into the housing 92 of the alternate power unit 42, may be directed into the engine air intake manifold in order to improve complete engine combustion, fuel efficiency and power.

The alternate power unit, particularly the housing 92 and rechargeable batteries 90 and associated components may be placed where convenient in the vehicle. For example, the alternate power unit being charged by lithium rechargeable batteries typically may be relatively small and lightweight and thus be able to be placed in, for example, a trunk of the vehicle. The enclosure may be comprised of a material to shield components therein from electromagnetic signals and audible noise emissions generated by operation of the vehicle.

As mentioned above, in accordance with the present invention, typically the alternator 14 is used only to recharge the vehicle-starting battery 16. The motor generator unit 40, electric regenerative braking system 44 and the like are used to recharge the rechargeable batteries 90 of the alternate power unit 42, and provide power to electrical components and accessories of the vehicle. The motor generator unit 40 may generate electricity for charging the rechargeable battery cells 90 of the alternate power unit 42 in static charge mode or regenerative charge mode. The motor generator unit 40 may provide motive power directly to the crankshaft and drive mode and regenerative braking in generator mode.

The motor generator unit may supply electric power to the batteries of the alternate power unit 42 by charging them while the vehicle is stopped and the engine of the vehicle is at idle, as a way of maintaining the minimum effective operating temperature in the catalytic converter. Otherwise, if the vehicle idles for a prolonged period of time, the exhaust temperatures may fall below a threshold temperature or effective operating temperature which can adversely affect the catalytic converter efficiency. This would enable full combustion of the vehicle emissions, particular nitrous oxides as when in the charging mode the motor generator unit 40 will place a load onto the crankshaft and then internal combustion engine 10. Moreover, the motor generator unit 40 may supply electric power to the batteries 90 of the alternate power unit 42 by charging resistance while the engine 10 of the vehicle is in optimum and most fuel-efficient RPM power range.

The motor generator unit motive force may be used in conjunction with the engine starter to proceed from a stop so as to minimize vehicle engine emissions. The vehicle engine 10 may be automatically stopped when sensors detect the internal temperatures of the catalytic converter have been cooled by prolonged engine idling and are approaching the effective low operating temperatures that limit full catalytic combustion of nitrous oxides, carbon monoxide, etc. Turning off the engine before it falls below the predetermined temperature has the effect of stabilizing temperatures in the catalytic converter, thus enabling full combustion of nitrous oxides and other pollutants when the engine restarts.

Another method for maintaining a minimum effective operating temperature of the catalytic converter is to inject hydrogen upstream of the catalytic converter in the exhaust, so as to maintain a minimum effective operating temperature in the catalytic converter that enables full combustion of the vehicle emissions. This may be done by electrolysis or any other conventional method, such as those disclosed in U.S. Pat. No. 7,808,118, the contents of which are hereby incorporated by reference.

Although several embodiments have been described in detail for purposes of illustration, various modifications may be made without departing from the scope and spirit of the invention. Accordingly, the invention is not to be limited, except as by the appended claims.

What is claimed is:

1. A process for coupling an electric generator unit to an engine of a vehicle, comprising the steps of:
providing a vehicle having an internal combustion engine with a crankshaft and a crankshaft pulley having a through-bolt extending through the crankshaft pulley; and
operably coupling a rotatable shaft of the motor generator unit to the crankshaft through-bolt or crankshaft pulley.

2. The process of claim 1, wherein the step of operably coupling step comprises the step of attaching a coupling between the motor generator shaft and the through-bolt of the crankshaft.

3. The process of claim 1, including the step of attaching a mounting flange to the crankshaft pulley or wall of the engine adjacent the crankshaft pulley.

4. The process of claim 3, including the step of attaching a motor generator unit to the mounting flange.

5. The process of claim 4, wherein the mounting flange and motor generator unit are not in direct contact with a harmonic balancer of the crankshaft pulley.

6. The process of claim 4, wherein the step of attaching the mounting flange comprises the step of inserting fasteners through the mounting flange and into the motor generator unit.

7. The process of claim 4, including the step of supporting a second end of the motor generator unit generally opposite the crankshaft.

8. A process for coupling an electric generator unit to an engine of a vehicle, comprising the steps of:
providing a vehicle having an internal combustion engine with a crankshaft and a crankshaft pulley having a through-bolt extending through the crankshaft pulley;
attaching a mounting flange to the crankshaft pulley or wall of the engine adjacent the crankshaft pulley;
attaching a motor generator unit to the mounting flange; and
attaching a coupling to a rotatable shaft of the motor generator unit and to the crankshaft through-bolt.

9. The process of claim 8, wherein the mounting flange and motor generator unit are not in direct contact with a harmonic balancer of the crankshaft pulley.

10. The process of claim 8, wherein the step of attaching the motor generator unit to the mounting flange comprises the step of inserting fasteners through the mounting flange and into the motor generator unit.

11. The process of claim 8, including the step of supporting a second end of the motor generator unit generally opposite the crankshaft.
